(19) United States
(12) Patent Application Publication
(10) Pub. No.: US 2019/0229419 A1
(43) Pub. Date: Jul. 25, 2019

(54) Apparatus Using a Folded Metal Antenna

(71) Applicant: Thomson Licensing, Cesson-Sevigne (FR)

(72) Inventors: William T Murphy, Lawrenceville, GA (US); John M McMillan, Buford, GA (US); Anthony Desantis, Dacula, GA (US)

(21) Appl. No.: 16/318,403

(22) PCT Filed: Apr. 7, 2017
(86) PCT No.: PCT/US2017/026597

§ 371 Date: Jan. 17, 2019

Related U.S. Application Data
(60) Provisional application No. 62/321,179, filed on Apr. 11, 2016.
(60) Provisional application No. 62/328,738, filed on Apr. 28, 2016.

(51) Int. Cl. H01Q 5/371; H01Q 1/24; H01Q 9/26; H01Q 1/22; H01Q 9/18

(52) U.S. Cl. CPC H01Q 5/371; H01Q 1/24; H01Q 9/18; H01Q 1/2291; H01Q 9/26

(57) ABSTRACT

An antenna apparatus for mounting on a non-conductive chassis with a printed circuit board includes a folded metal antenna element having an integral folded metal balun, wherein the balun is connected to the folded metal antenna, and metal end portions on the folded metal balun connect with conductive pads on a printed circuit board. The pads directly connect to RF circuitry on the printed circuit board such that an electrical connection between the metal end portions of the folded metal balun and the RF circuitry is made without an RF cable or separate connector.

### CROSS REFERENCE TO RELATED APPLICATIONS

This application claims the benefit of United States provisional patent application No. 62/321,179 filed 11 Apr. 2016, and United States provisional patent application No. 62/328,738 filed 28 Apr. 2016, which are incorporated by reference herein in their entirety for all purposes.

### FIELD

The present principles relate to an antenna, specifically, a folded antenna to be mounted on a non-conductive chassis and connected to a printed circuit board.

### BACKGROUND

Even though printed circuit trace antennas have many advantages including cost, there are tradeoffs that cause antenna designers to mount antennas on the walls of a non-conductive chassis. Prior art shows examples where the chassis mounted antenna is made of various materials. These antennas require a means to conduct the RF signal from the radio on the main printed circuit board to the antenna. Generally, a small RF cable and on-board ultra-small surface mount coaxial connector is used for the connection. An example ultra-small surface mount coaxial connector is a U.FL type of connector made by Hirose Electric Group, but other manufacturers also exist.

U.FL type connectors are commonly used in applications where space is of critical concern; often in small printed circuit boards. U.FL type connectors are commonly used inside laptops, set-top boxes, and other embedded systems to connect the Wi-Fi antenna to a printed circuit card. Female U.FL type connectors are not designed with reconnection in mind, and they are only rated for a few reconnects before replacement is needed. The male connectors are surface-mounted and soldered directly to the printed circuit board (PCB). The disadvantages of using a U.FL type connector approach to antenna mounting include the following: the cost of the cable and U.FL type connector, the cost of hand soldering the cable to the antenna, the cost of assembling the chassis and the board, managing the antenna cable routing, and plugging the antenna cable into the U.FL type connector multiple times for testing. An alternative approach to connecting a chassis-mounted antenna to a printed circuit card is desirable.

### SUMMARY

This summary is provided to introduce a selection of concepts in a simplified form as a prelude to the more detailed description that is presented later. The summary is not intended to identify key or essential features, nor is it intended to delineate the scope of the claimed subject matter.

In one embodiment, an antenna apparatus includes a folded metal antenna and an antenna support member. In addition, the antenna apparatus can include all or some of the following features. The folded metal antenna includes a metal balun formed of folded metal, wherein the metal balun comprises two metal sides. The metal sides have metal contact end portions for electrical connection. The antenna support member has a spacer portion placed between the two metal sides of the metal balun. The antenna support member provides mechanical support for the antenna apparatus. The metal contact end portions connect with conductive pads on a printed circuit board, wherein the printed circuit board is removably connected to the antenna apparatus. The antenna apparatus is connected to the printed circuit board absent an RF cable or RF connector. The two metal sides of the metal balun may be curved in shape.

The folded metal antenna forms a dipole antenna wherein the dipole antenna is either one of a dual band antenna or a single band antenna. The folded metal antenna is mounted away from an inside wall of a chassis. A spacer portion of the antenna support member placed inside the metal balun controls the separation of the two metal sides. The dimensions of the apparatus are selected to advantageously position the metal balun in alignment with a gap between vertical members of the folded metal antenna, thereby allowing the antenna support member to provide mechanical support for the folded metal antenna. The antenna apparatus includes a floor structure of the antenna support member to support the metal contact end portions of the metal balun. The floor structure is made of a non-conductive material. The metal contact end portions act as feet to rest upon the floor structure. The metal contact end portions of the metal balun are formed at an angle greater than 90 degrees to produce a spring-like action when pressed against the floor structure of the antenna support member. The spacer portion of the antenna support member includes a widening of the spacer portion above the floor structure which causes the metal contact end portions of each side of the metal balun to be pushed outward slightly. An impedance of the antenna apparatus is controlled by a ratio between a width of the two metal sides of the metal balun and a gap between the two metal sides of the metal balun. An electronic device which includes an antenna apparatus as described above may be either a gateway device or a set-top box.

Additional features and advantages will be made apparent from the following detailed description of illustrative embodiments which proceeds with reference to the accompanying figures. The drawings are for purposes of illustrating the concepts of the disclosure and is not necessarily the only possible configuration for illustrating the disclosure. Features of the various drawings may be combined unless otherwise stated.

### BRIEF DESCRIPTION OF THE DRAWINGS

The foregoing summary, as well as the following detailed description of illustrative embodiments, is better understood when read in conjunction with the accompanying drawings, which are included by way of example, and not by way of limitation with regard to the present principles. In the drawings, like numbers represent similar elements.

FIG. 1(a) is a left side isometric view of a folded metal antenna design without a balun according to principles of the disclosure;

FIG. 1(b) is a front view of a folded metal antenna design without a balun according to principles of the disclosure;

FIG. 2(a) is a left side isometric view of a folded metal antenna design with a balun according to principles of the disclosure;

FIG. 2(b) is a front view of a folded metal antenna design with a balun according to principles of the disclosure;

FIGS. 3 depicts a folded metal antenna placed inside a chassis according to principles of the disclosure;

FIG. 4(a) depicts a folded metal antenna before installation into a chassis according to principles of the disclosure:

FIG. 4(b) depicts a folded metal antenna after installation into a chassis according to principles of the disclosure;

FIG. 5 depicts an underside view of the folded metal antenna with the antenna support member hidden according to principles of the disclosure;

FIG. 6(a) depicts another embodiment of the folded metal antenna before it is lowered or installed into place on a support spacer portion of the antenna support member according to principles of the disclosure;

FIG. 6(b) depicts an expanded front view of the embodiment of FIG. 6(a) according to principles of the disclosure;

FIG. 7(a) depicts a widened spacer feature according to principles of the disclosure;

FIG. 7(b) depicts an expanded spacer feature view of the embodiment of FIG. 7(a) according to principles of the disclosure;

FIG. 8 depicts a fully installed folded metal antenna including the features of FIG. 7(b) according to principles of the disclosure; and

FIG. 9 depicts the metal antenna before full folding according to principles of the disclosure.

### DETAILED DISCUSSION OF THE EMBODIMENTS

In the following description of various illustrative embodiments, reference is made to the accompanying drawings, which form a part thereof, and in which is shown, by way of illustration, how various embodiments may be practiced. It is to be understood that other embodiments may be utilized and structural and functional modification may be made without departing from the scope of the present principles.

The configuration disclosed herein of a folded antenna could find application in many wireless or Wi-Fi products that have mechanically flat, horizontal surface mounted boxes. These boxes typically have a circuit board whose planar surface is horizontal. The concept of a folded antenna as disclosed herein exploits the fact that vertically polarized electromagnetic waves travel substantially unmolested across a horizontal conductive surface such as a circuit board. Vertically polarized antennas are substantially unaffected when located in close proximity to horizontal conductive surfaces, such as a PC board. Therefore, vertically polarized antennas are a good choice alternative in a horizontal box when an omni-directional radiation pattern in the horizontal plane is desired.

The drawback to vertically polarized antennas is the required length of the antenna oriented in the direction of polarity. At 2.4 GHz, the required dipole length is around 62 mm But the height of many horizontal devices is rarely higher than 25 to 30 mm As is currently known, Wi-Fi boxes, such as set-top boxes, gateways, and the like, continue to shrink in height. Therefore, vertically polarized dipoles present a challenge to be utilized in horizontal boxes. The vertically polarized antenna solution alternative in a small chassis size, plus the desire to eliminate the use of RF cables and ultra-small coax connectors in attaching an antenna to a PCB help inspire this disclosure.

Aspects of the novel configuration include a folded metal antenna which may be mounted on a small non-conductive (usually plastic) surface close to the edge of a plastic chassis. The antenna makes connection to a printed circuit board (PCB) using the end portions of two metal sections that form a balun and extend down to the PCB. The plastic chassis and the PCB are formed such that the metal sections are secured into place and connected to the RF circuitry on the main PCB by means of exposed bottom side pads and copper traces on the PCB. The RF circuitry can include an on-board radio or RF transmitter and/or receiver circuitry as known to those of skill in the art. The connection to the balun and thus the folded metal antenna to the RF drive and receiver circuitry is made when the PCB is simply inserted onto the antenna support member chassis causing the folded metal balun of the antenna to contact the exposed bottom side pads in the PCB.

In the disclosed current configuration, one possible advantage of a chassis mounted antenna includes connection of RF circuitry (transmitter and/or receiver) to an antenna without an RF cable between the RF circuitry on the PCB and the antenna. Another possible advantage is the effective construction of an antenna balun that connects directly at the folded antenna and connects to the conductive pads on a PCB that includes the RF circuitry.

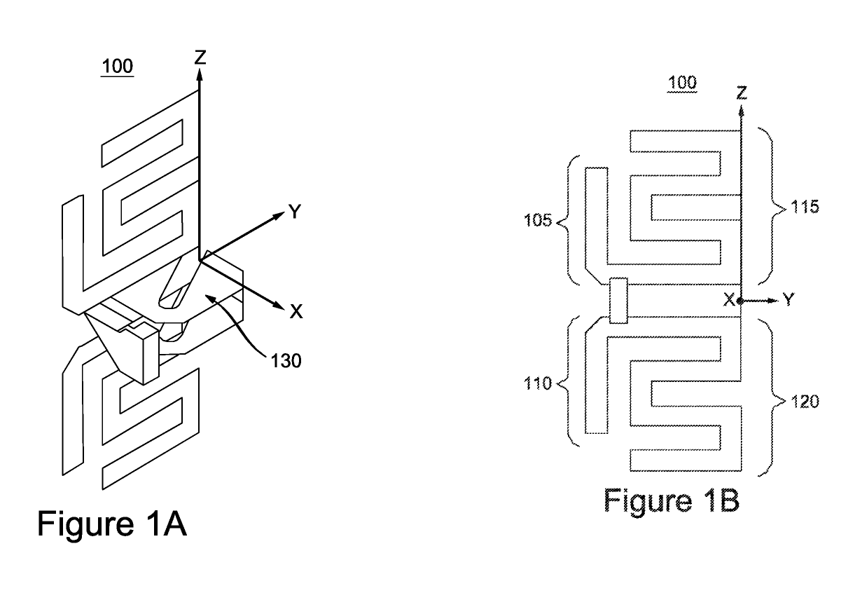

FIGS. 1(a) and 1(b) depict a folded antenna design. The antenna may be manufactured from sheet metal as a stamping and then folded at the correct positions to generate the folded metal antenna shown in FIGS. 1(a) and 1(b). The antenna design represents one embodiment of a dual band vertically polarized dipole antenna. In one embodiment, the dual bands include 2.4 GHz and 5 to 6 GHz; such as that used in some Wi-Fi applications found in laptops, gateways, and other wireless devices. FIG. 1(a) shows an isometric view of the folded metal antenna 100. FIG. 1(b) shows a front view of the folded metal antenna 100. As depicted in FIG. 1(a) and (b), the upper (north pole) 5 to 6 GHz element 105 is connected to the lower (south pole) 5 to 6 GHz element 110 via an impedance matching structure 130. Likewise, the upper (north pole) 2.4 GHz element 115 is connected to the lower (south pole) 2.4 GHz element 120 via the impedance matching structure 130. The metal and metal plating used in the antenna 100 may be any suitable metal including aluminum, copper, tin, or other metal or alloy known to those of skill in the art. It is also noted that the metal plating of the antenna and the metal contact on the PCB are advantageously of similar or compatible substance to prevent galvanic corrosion in the contact between the two structures.

The embodiment of FIG. 1 is an example folded metal antenna characterized as being a dual band dipole. One application for this antenna is in a Wi-Fi application. As is well appreciated by one of skill in the art, other embodiments are realizable. For example, a folded metal antenna could be configured to be a single band antenna, such as a dipole or a monopole and be applied in applications such as Wi-Fi, cellular, ZigBee, Z-Wave, Bluetooth, and the like.

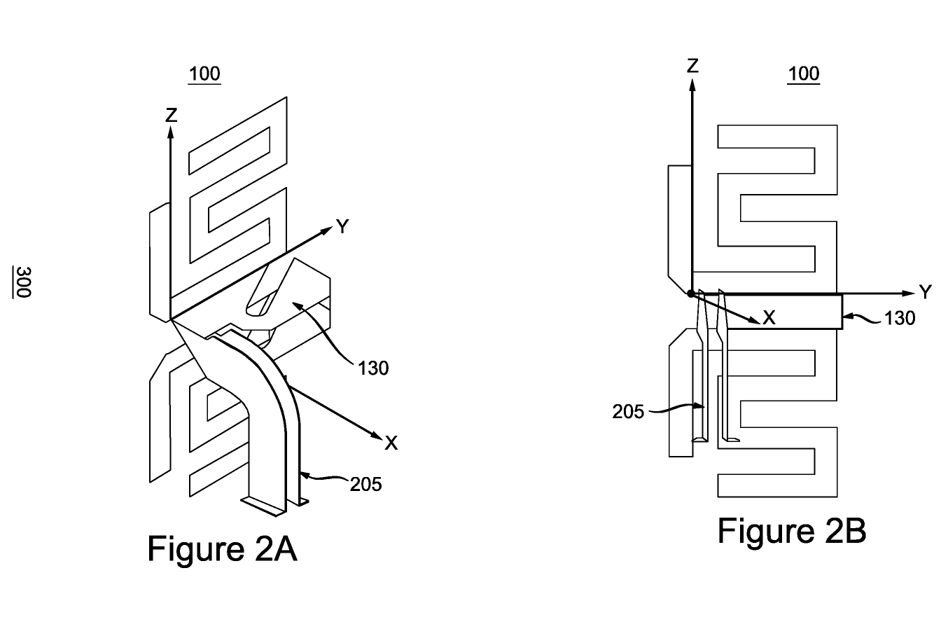

FIGS. 2(a) and (b) illustrates a folded metal antenna 100 with a balun 205 installed. Advantageously, the balun 205 of the embodiment of FIG. 2(a) is constructed of two folded metal pieces where the folded metal pieces act to control the electrical interface impedance to the folded metal antenna. FIG. 2(a) shows the folded metal antenna with balun installed in an isometric view. FIG. 2(b) shows the folded metal antenna with the balun in a front view.

The bottom (-z axis) of the folded metal balun 205 is designed to extend to a PCB. The PCB is not shown in FIG. 2(a). However, the RF signal from RF circuitry on the PCB can be transmitted from the PCB circuitry to the antenna 100 via the balun 205. In one embodiment the balun 205 impedance is tuned for 50 ohms by adjusting the dimensions of the two metal pieces extending to the PCB. The specific ratio between width of the two pieces and the gap between them sets the desired impedance. Although the balun 205 of the example antenna of FIG. 2(a) depicts a curved balun member with essentially flat sides, it is within the scope of the disclosed design to implement the balun member as one or more straight members and or with rounded sides. Thus, other geometric cross sections for the balun are contemplated other than the curved and flat sided balun 205 shown in FIGS. 2(a) and 2(b).

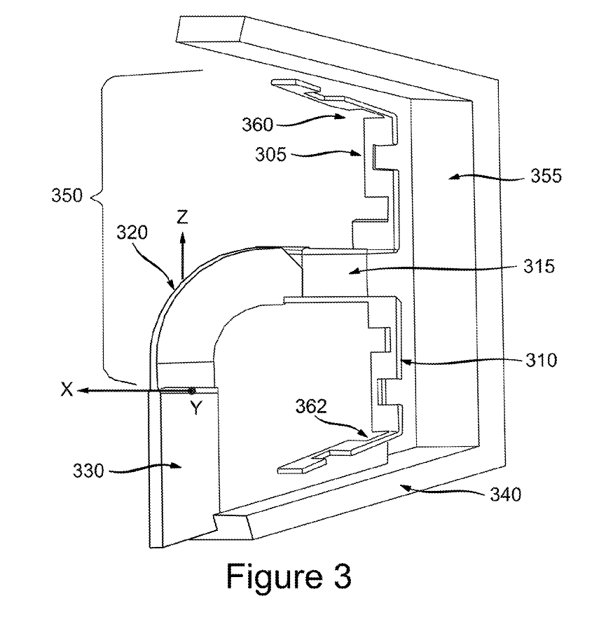

FIG. 3 depicts an example configuration 300 for use of a folded metal antenna 350 in an electronics box having constrained internal height dimensions. In FIG. 3, the folded metal antenna 350 includes an upper element set 305, a lower element set 310, an impedance matching structure 315, and a balun 320. The balun rests on a support structure 330 which may be part of the chassis 340 of the electronics enclosure box shown in sliced detail. The implementation configuration 300 overcomes the challenge of shrinking electronics box size by combining a folded metal antenna design with a fold in the metal antenna itself to allow the folded metal antenna 350 to fit in a vertical space as small as 20 mm In the example of FIG. 3, the folded metal antenna 350 is bent in the upper element set 305 at location 360 and the lower element set 310 is bent at location 362 to accommodate the internal height constraints of an electronics enclosure having height constraints.

FIG. 3 depicts an aspect of the configurataion 300 which includes a dedicated non-conductive mechanical support member 330 which can emerge from the chassis floor 340 instead of a chassis interior sidewall. FIG. 3 indicates that there can advantageously be an air gap between the folded antenna structure 350 and the inside of the chassis wall 355 of an electronics enclosure. The air gap allows the folded antenna 350 to function without being permanently attached to the interior chassis wall 355 of the electronics enclosure.This feature allows for easy antenna replacement or servicing as needed. Note shown in FIG. 3 is the PCB which can be placed over the contact end portions of the balun 320 to provide electrical connection of the antenna to the RF drive circuitry on the PCB. Other bend locations, if needed, are contemplated within the scope of the disclosed design.

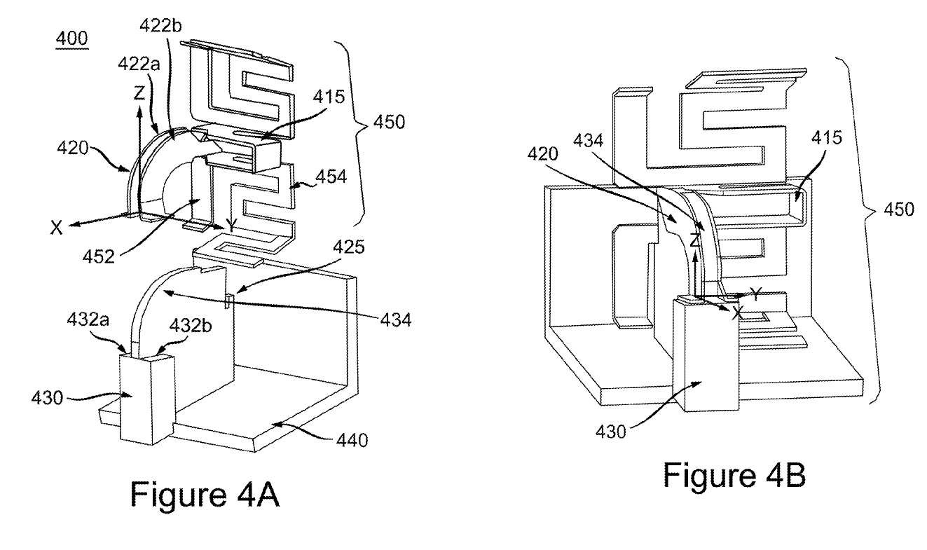

In an embodiment shown in FIGS. 4(a) and 4(b), mounting the folded metal antenna 450 in a non-conductive chassis 440 is accomplished with a non-conductive antenna support member 430, made of either plasitic, composite, or other non-conductive material, that the balun portion 420 of the antenna straddles. FIG. 4(a) depicts the non-conductive antenna support member 430 as a structural member which serves to support the antenna 450. The antenna support member 430 includes both a spacer portion 434 to support the balun 420 and two floor portions 432a, 432b to support the metal contacts of the balun 420. Although the antenna support member may be attached to a chassis, the attachement to the chassis is not considered part of the antenna support member 430. When installed, the spacer portion 434 of the antenna support member 430 is placed inside the metal balun 420 and controls the separation of the two metal sides 422a, 422b that make up the balun 420. Typically, such a spacer is made of non-conductive material so as to not interfere with the transmission or reception of the folded metal antenna. The antenna support member also supports the upper and lower half of the folded metal antenna 450. In an alternative embodiment, not shown, the antenna support member continues to support the separation of the balum sides, but is not the only support member for the antenna.

In the embodiment of FIG. 4(a), the antenna 450 is not yet installed and the antenna support member 430 is shown as a non-conductive element which is roughly perpendicular to the inside wall of the electronics enclosure box that houses the antenna 450 structure. This non-conductive antenna support member 430 acts to hold the antenna 450 in place in the chassis 440 while the PCB (not shown) is inserted onto the metal contact end portions (feet) of the balun 420. In FIGS. 4(a) and (b), the dimensions of the antenna 450 are selected to advantageously position the balun connection to the antenna elements in alignment with the air gap between the vertical elements (north and south pole elements) of the antenna 450, thereby allowing the antenna support member 434 to provide mechanical features for supporting the antenna 450. The air gap between the vertical elements is also occupied by the impedance matching structure 415. In one aspect of the embodiment of FIG. 4(a), the mechanical support feature 425 is placed advantageously because the balun 420 is aligned with the gap (space) between the lowband part 454 and highband part 452 of the antenna 450. This placement is possible because of the the gap (space) in the lower (south pole) elements of the antenna that is open and available for a plastic spacer 434 to be inserted.

FIG. 4(b) depicts the folded antenna 450 fitted over the antenna support member 430. In one aspect of the configuration, the antenna support member 430 also provides structural support for the interior of the balun 420. This serves the multiple purpose of controlling balun electrical characteristeics, such as impedance, which is affected by the separation of the metal sides of the balun 420, and mechanically supporting the balun 420 and the structure of the folded antenna 450. The folded antenna 450 and antenna support member 430 may be considered an antenna apparatus.

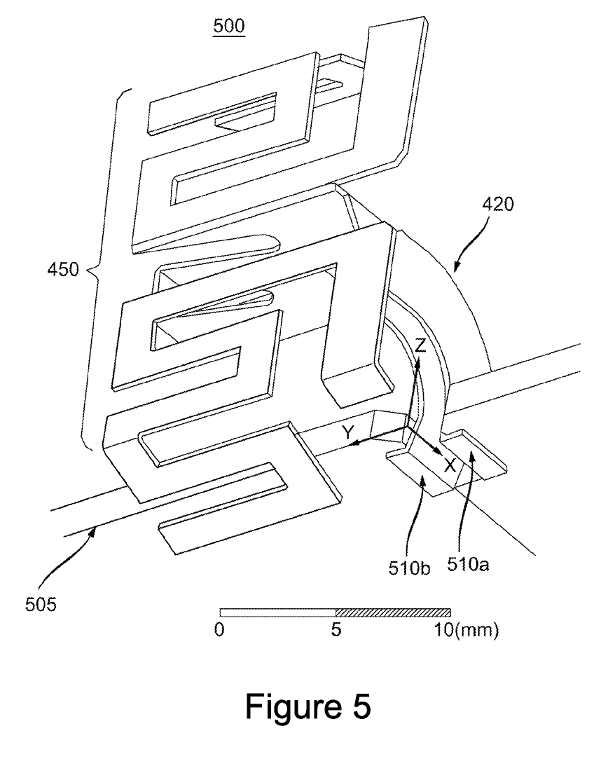

FIG. 5 depicts a view 500 of the antenna structure 450 connecting to a PCB 505 from the bottom with the antenna support member 430 hidden. This view 500 also shows the folds in the dipole antenna elements which allows the antenna 450 to fit vertically in a small chassis. Also shown are the metal antenna contact end portions (feet) 510a, 510b which allow electrical connection to the PCB 505 via traces on the PCB. Notice that there is a slot in the PCB 505 to allow the insertion of the PCB 505 over the balun 420. During assembly, after the antenna 450 is installed on antenna support member 430, the PCB 505 can be slid over the antenna support member 430 (not shown in FIG. 5). The PCB, once slid onto the floor structure 432a, 432b of the antenna support member 430, makes contact with each metal piece (feet) of the base of the balun 420. This contact provides an opportunity for the RF circuity to drive the balun with an RF signal or receive signal from the folded metal antenna. Notably, the PCB, once installed onto the balun contact end portions (balun feet) may also be removed for inspection, rework, or other purpose and re-installed. The PCB 505 is thus removably connected to the antenna 450 and antenna support member 430. Another feature shown in FIG. 4b and FIG. 5 is that the folded metal antenna, once installed onto the antenna support member 430, has the north pole antenna elements above the PCB and the south pole elements below the PCB. This effective use of space reduces the vertical height of a dipole antenna above a PCB.

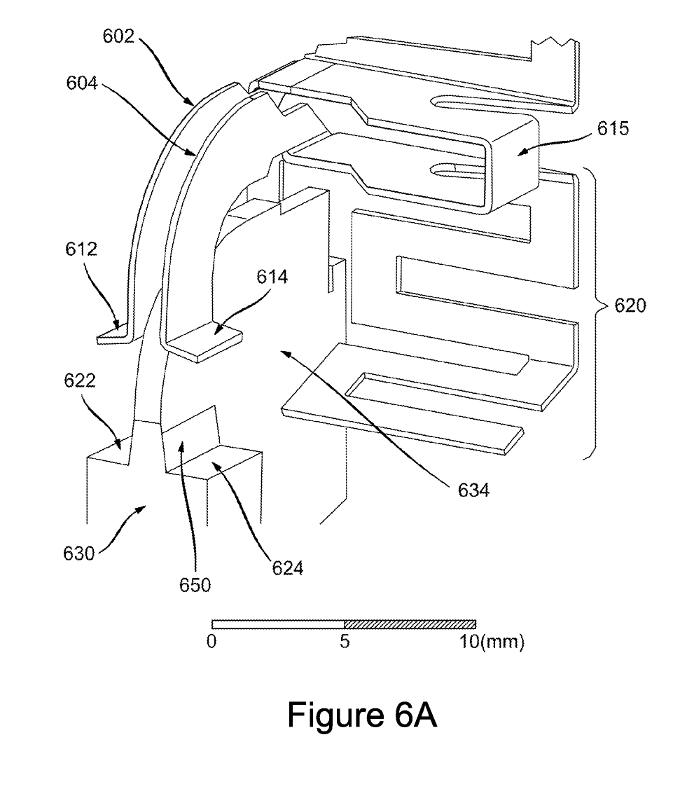

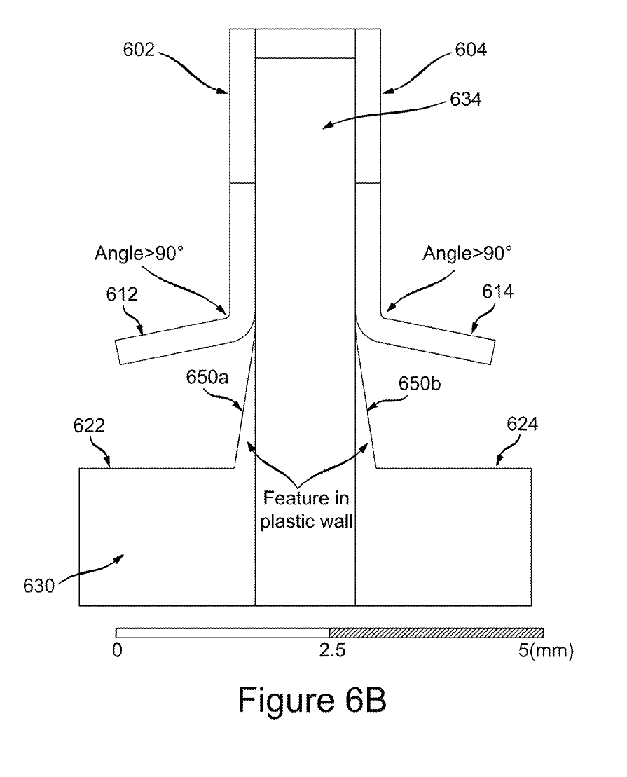

FIG. 6(a) depicts another embodiment of the folded metal antenna, similar to that of FIG. 4(a), but with greater detail concerning the antenna support member. FIG. 6(a) depicts a folded metal antenna before it is lowered or installed into place on an antenna support spacer portion 634 of the antenna support member 630. As in the basic design of the folded antenna of FIG. 1(b), the lower (south pole) 2.4 GHz element 620 is connected to an impedance matching structure 615 and is further connected to the balun sides 602 and 604. Balun side member 602 ends in a contact end portion (foot) 612. Balun side member 604 ends in a contact end portion (foot) 614. Once the folded metal antenna is placed upon the antenna support member 630, balun foot 612 rests upon floor structure 622 and balun foot 614 rests upon floor structure 624. The feet 612, 614 of the balun rest upon floor structure 622, 624 of the antenna support member 630, which includes the support spacer portion 634.

In the embodiment of FIG. 6(a), a spring-like mechanism is provided that ensures mechanical contact between the metal balun end portions (feet) 612 and 614 of the antenna and the conductive pads on the bottom side of the PCB (not shown in FIG. 6(a). The spring-like mechanism addresses the design of the metal antenna in the location of the balun where it contacts the PCB. The spring-like mechanism of the feet 612, 614 function to make electrical and mechanical contact between the balun end portions (feet) and the PCB when the PCB is place onto the top of the feet 612, 614. In the embodiment of FIG. 6(a), instead of a 90° fold at the feet, the angle between the feet and the balun portion of the antenna is increased slightly to be greater than 90°.

FIG. 6(b) depicts an expanded front view of the embodiment of FIG. 6(a) also before the antenna is lowered into place. In the example of FIG. 6(b), the fold of the balun feet are approximately 100° between the feet 612, 614 and the balun sides 602, 604 portion of the folded metal antenna. Another feature of the embodiment of FIG. 6(a), is added in the plastic spacer portion 634 of the antenna support member 630. This feature is a gradual widening of the spacer portion 650a, 650b of the antenna support member 630 just above the floor structure 622, 624 of the antenna support member 630. This widening feature causes the foot (metal end portion) of each side of the balun to be pushed outward slightly. In the embodiment shown in FIG. 6(b), the outward distance is approximately 0.25 mm. This added feature, a gradual widening 650a, 650b of the spacer portion 634 of the antenna support member 630, may be added to one or preferably both sides of the plastic spacer portion 634.

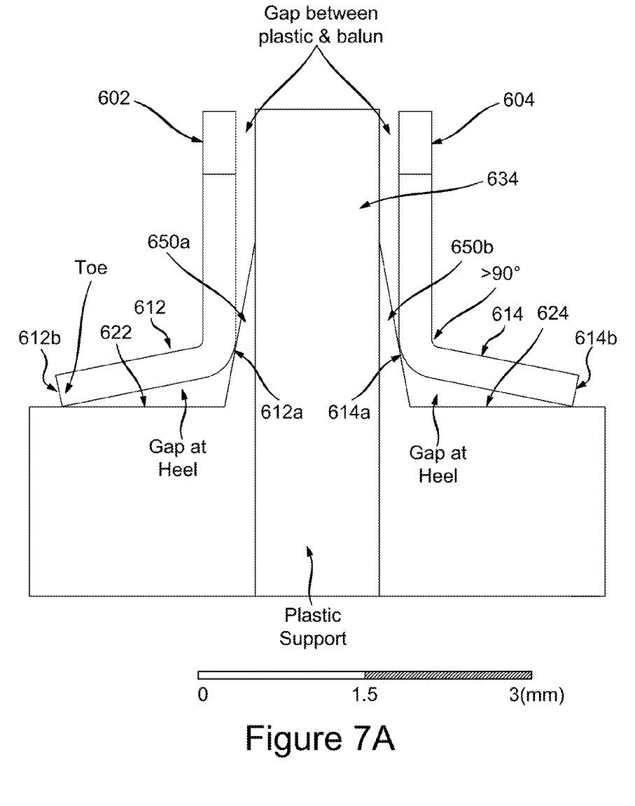

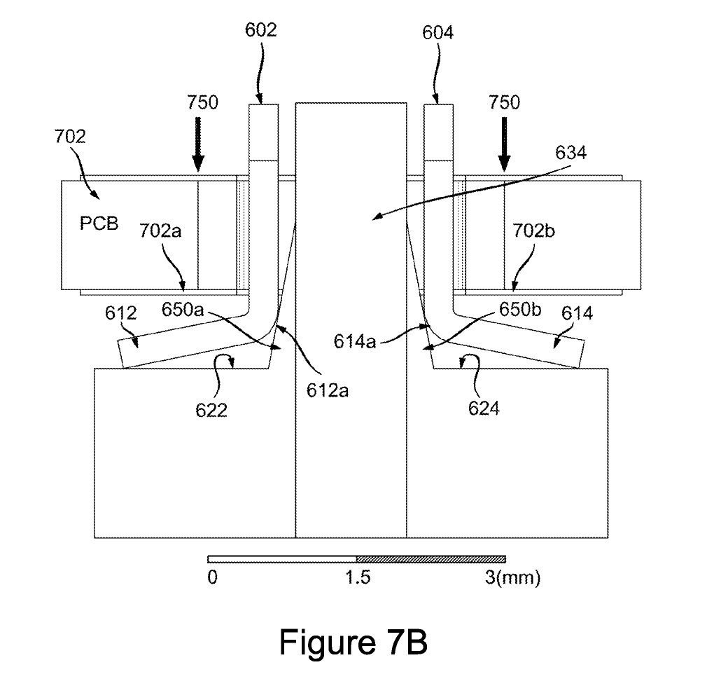

FIG. 7(a), when the antenna is lowered into place, the gradual widening 650a, 650b feature described above with respect to FIG. 6(b) pushes the balun sides 602, 604 outward slightly. This opening of the balun sides causes a gap at the balun feet 612, 614 heel 612a, 614a between the antenna support member floors 622, 624 and balun feet 612, 614. Vertically, the antenna is stopped on both sides by the toes 612b, 614b of the balun foot 612, 614 which is lower than the heels 612a, 614a, due to the heel angle of the foot being >90°. With these gaps at the heel, a spring like action is accomplished when the PCB is inserted and pressed into place. FIG. 7(b) depicts the configuration of FIG. 7(a) as an expanded front view of the effect that the widened spacer features 650a, 650b have as the antenna feet 612, 614 are pushed into place using a PCB 702. The PCB 702 is installed downward onto and over the sides 602, 604 of the balun. The downward force 750 of the PCB 702 onto the antenna support member 634 starts the spring-like compression of the balun feet 612, 614 onto the floor surfaces 622, 624 of the antenna support member 634.

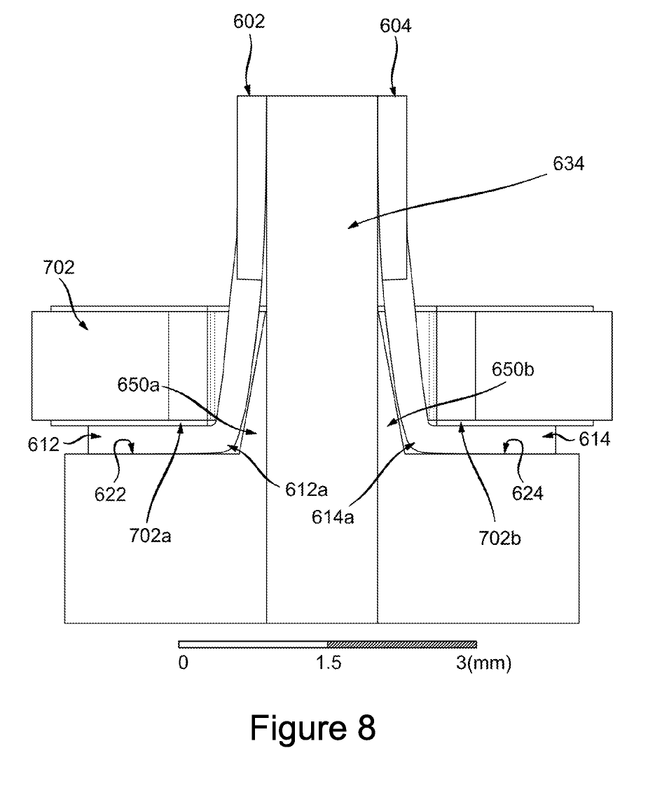

FIG. 8 depicts a folded metal antenna balun portion showing the balun sides 602, 604 installed onto the antenna support member 634 using pressure from an installed PCB 702 having the widening spacer features 650a, 650b of FIGS. 6(a-b) and FIGS. 7(a-b). FIG. 8 depicts an example of the now-compressed spring-like action of the above-described widening spacer features 650a, 650b of the folded balun feet 612, 614 after assembly of the PCB 702 onto the antenna balun feet. The PCB 702 drives the heels 612a, 614a downward flattening both feet 612, 614. This, in turn closes the gap between the balun and the plastic spacer. This insures spring force is maintained between the electrical contact pads 702a, 702b (PCB electrical traces) and the antenna feet 612, 614 in both locations. As noted before the electrical contact pads 702a, 702b serve to connect the balun feet 612, 614 to RF drive and receiver circuitry on the PCB 702 to drive the folded metal antenna. Note that in FIG. 8, the balun sides 602, 604 are slightly bent after full compression. For example, side 602 is slightly curved from the upper portion of the balun side 602 to the heel 612a to accommodate the widening feature 650a of the antenna support member 634. The same conforming curvature is observed on side 604 to heel 614a.

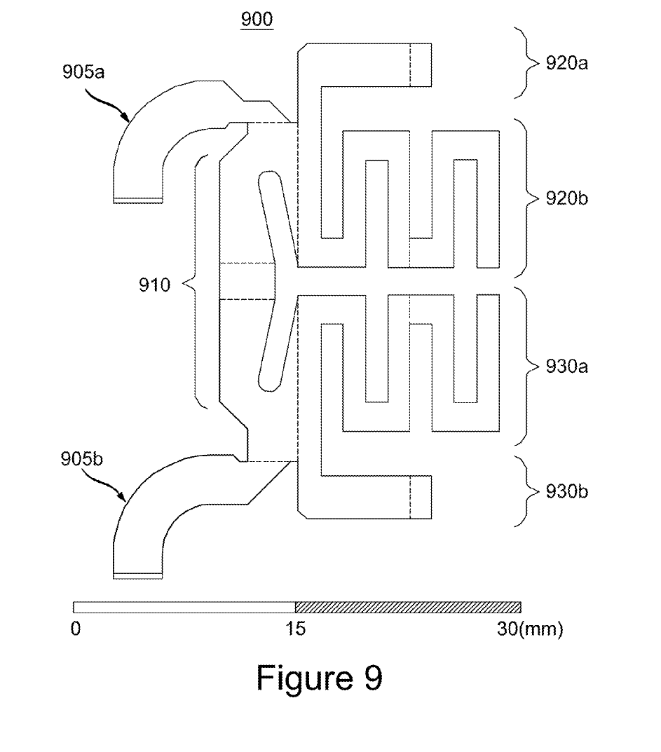

FIG. 9 depicts a layout of one embodiment of the antenna stamping before it is fully folded. In the depiction of FIG. 9, the balun contact end portions (feet) are already folded; the rest of the antenna is yet to be folded. Folds lines are indicated by dotted lines. The embodiment of FIG. 9 is similar in function to that of FIGS. 1(a,b). The balun portion of the antenna is represented by the curved portions 905a, 905b of the unfolded antenna. The impedance matching structure 910 bridges the unfolded dipole elements. The upper dipole elements (north pole) includes a 5 GHz element 920a and a 2.4 GHz element 920b. The lower dipole elements (south pole) includes a 5 GHz element 930b and a 2.4 GHz element 930a. One of skill in the art will appreciate that the unfolded metal antenna of FIG. 9 is not the only configuration of a foldable metal antenna. Other configurations are possible for other applications such as single band antennas.

In one aspect of the disclosure, the features of the various figures can be combined. For example, features from FIGS. 6(a), 6(b), 7(a), 7(b), 8, and 9 may be added and/or combined with features of FIGS. 4(a), 4(b), and 5 without conflict as can be well-appreciated by one of skill in the art. Thus, features in the drawings may be considered compatible and may be combined into an embodiment regardless of the different numbering of the drawing reference numbers unless otherwise specified. One possible advantageous feature of the attachment configuration, where a PCB is placed over contact end portions (feet) of a balun of a folded metal antenna, is that a direct connection is made between the balun end portions (feet) of the folded metal antenna and traces on the PCB which connect to the RF drive and receive circuitry. In this configuration, this balun connection is made to contact pads on the PCB traces without (absent) the use of an RF cable or a separate connector, such as an ultra-small surface mount coaxial connector. Thus, the connection is simpler, more direct, and avoids the use of additional components such as RF cables or separate connectors.

The advantages of the above-described configuration for a folded metal antenna can also include ease of testing before final assembly. For instance, before final assembly, the PCB with the RF circuitry can be tested on a test jig that includes an antenna or antenna load that connects to the PCB via the slot that accommodates the balun end portions of the above-described configuration. After final assembly, wherein a refurbishment or test condition exists, the PCB can be tested by simply removing the PCB from the balun end portions of the folded metal antenna because the balun end portions are not soldered to an RF cable of connector that needs to be removed. Thus, the antenna and PCB are removably connected absent (without) the use of solder joints, RF cables, or RF connectors. In one test environment, the antennas are removable because antennas must be characterized while loaded by the rest of the box and the other antennas. Removable antennas provide flexibility in testing. One of skill in the art notes that the disclosed configuration allows PCB and antenna removal without removing RF connectors, de-soldering, or other normally invasive techniques used in the disassembly of cable-connected or solder-connected antenna assemblies.

1. An antenna apparatus, the antenna apparatus comprising:
a folded metal antenna including a metal balun formed of folded metal, wherein the metal balun comprises two metal sides, the metal sides having metal contact end portions for electrical connection; and
an antenna support member, having a spacer portion placed between the two metal sides of the metal balun.

2. The antenna apparatus of claim 1, wherein the antenna support member provides mechanical support for the antenna apparatus.

3. The antenna apparatus of claim 1, wherein the metal contact end portions connect with conductive pads on a printed circuit board, wherein the printed circuit board is removably connected to the antenna apparatus.

4. The antenna apparatus of claim 3, wherein the antenna apparatus is connected to the printed circuit board absent an RF cable or RF connector.

5. The antenna apparatus of claim 1, wherein the two metal sides of the metal balun are curved in shape.

6. The antenna apparatus of claim 1, wherein the folded metal antenna forms a dipole antenna and wherein the dipole antenna is either one of a dual band antenna or a single band antenna.

7. The antenna apparatus of claim 1, wherein the folded metal antenna is mounted away from an inside wall of a chassis.

8. The antenna apparatus of claim 1, wherein a spacer portion of the antenna support member placed inside the metal balun controls the separation of the two metal sides.

9. The antenna apparatus of any claim 1, wherein the dimensions of the apparatus are selected to advantageously position the metal balun in alignment with a gap between vertical members of the folded metal antenna, thereby allowing the antenna support member to provide mechanical support for the folded metal antenna.

10. The antenna apparatus of claim 1, further comprising a floor structure of the antenna support member to support the metal contact end portions of the metal balun.

11. The antenna apparatus of claim 10, wherein the floor structure is made of a non-conductive material.

12. The antenna apparatus of claim 10, wherein the metal contact end portions act as feet to rest upon the floor structure.

13. The antenna apparatus of claim 10, wherein the metal contact end portions of the metal balun are formed at an angle greater than 90 degrees to produce a spring-like action when pressed against the floor structure of the antenna support member.

14. The antenna apparatus of claim 1, wherein the spacer portion of the antenna support member includes a widening of the spacer portion above the floor structure which causes the metal contact end portions of each side of the metal balun to be pushed outward slightly.

15. The antenna apparatus of claim 1, wherein an impedance of the antenna apparatus is controlled by a ratio between a width of the two metal sides of the metal balun and a gap between the two metal sides of the metal balun.

16. An electronic device comprising:
an antenna apparatus, the antenna apparatus comprising:
a folded metal antenna including a metal balun formed of folded metal, wherein the metal balun comprises two metal sides, the metal sides having metal contact end portions for electrical connection: and
an antenna support member, having a spacer portion placed between the two metal sides of the metal balun.

17. An electronic device according to claim 16 wherein the electronic device is a gateway device or a set-top box.
